(19) United States
(12) Patent Application Publication
(10) Pub. No.: US 2021/0301943 A1
(43) Pub. Date: Sep. 30, 2021

(54) DISPENSING UNIT HAVING FIXED FLEXIBLE DIAPHRAGM SEAL

(71) Applicant: Illinois Tool Works Inc., Glenview, IL (US)

(72) Inventors: Ronald J. Forget, Douglas, MA (US); Thomas J. Karlinski, Atkinson, NH (US)

(21) Appl. No.: 17/181,562

(22) Filed: Feb. 22, 2021

Related U.S. Application Data
(60) Provisional application No. 63/000,814, filed on Mar. 27, 2020.

(51) Int. Cl. F16K 41/04; B05C 5/02; B05C 11/10

(52) U.S. Cl. CPC F16K 41/04; B05C 11/1026; B05C 5/0225

(57) ABSTRACT

A dispensing unit of a dispensing system configured to dispense viscous material on an electronic substrate includes a support housing and a fluidic housing supported by the support housing. The fluidic housing includes a chamber and an inlet configured to deliver viscous material to the chamber from a material feed tube. The dispensing unit further includes a nozzle assembly releasably secured to the housing and configured to close an end of the fluidic housing. The dispensing unit further includes a reciprocating piston disposed partially within the chamber of the fluidic housing. The piston is configured to dispense viscous material from the nozzle assembly. The dispensing unit further includes a fixed flexible diaphragm seal configured to be secured to the fluidic housing and to the piston.

### RELATED APPLICATIONS

This application claims priority under 35 U.S.C. § 119(e) to U.S. Provisional Application Ser. No. 63/000,814 titled “DISPENSING UNIT HAVING FIXED FLEXIBLE DIAPHRAGM SEAL” filed on Mar. 27, 2020, which is herein incorporated by reference in its entirety.

### BACKGROUND OF THE DISCLOSURE

### 1. Field of the Disclosure

This disclosure relates generally to apparatus and methods for dispensing a viscous material on a substrate, such as a printed circuit board, and more particularly to an apparatus and a method for dispensing material on a substrate with a dispensing unit having a reciprocating piston disposed within a fluidic housing and a fixed flexible diaphragm seal that is configured to provide a seal between the inner fluid pressure and atmosphere.

### 2. Discussion of Related Art

There are several types of dispensing systems used to dispense precise amounts of liquid or paste for a variety of applications. One such application is the assembly of integrated circuit chips and other electronic components onto circuit board substrates. In this application, automated dispensing systems are used for dispensing dots of liquid epoxy or solder paste, or some other related material, onto printed circuit boards. Automated dispensing systems are also used for dispensing lines of underfill materials and encapsulants, which may be used to mechanically secure components to the printed circuit board. Exemplary dispensing systems described above include those manufactured and distributed by Illinois Tool Works Electronic Assembly Equipment (ITWEAE), with offices at Hopkinton, Massachusetts.

In a typical dispensing system, a dispensing unit is mounted to a moving assembly or gantry for moving the dispensing unit along three mutually orthogonal axes (x-axis, y-axis, and z-axis) using servomotors controlled by a computer system or controller. To dispense a dot of liquid on a printed circuit board or other substrate at a desired location, the dispensing unit is moved along the co-planar horizontal x-axis and y-axis directions until the dispensing unit is located over the desired location. The dispensing unit is then lowered along the perpendicularly oriented vertical z-axis direction until a nozzle/needle of the dispensing unit and dispensing system is at an appropriate dispensing height over the substrate. The dispensing unit dispenses a dot of liquid, is then raised along the z-axis, moved along the x- and y-axes to a new location, and is lowered along the z-axis to dispense the next liquid dot. For applications such as encapsulation or dispensing of underfill as described above, the dispensing unit is typically controlled to dispense lines of material as the dispensing unit is moved in the x- and y-axes along the desired path of the lines. For some types of dispensing units, such as jetting pumps, the z-axis movement prior to and subsequent to a dispense operation may not be required.

FIG. 1 illustrates a portion of a typical dispensing unit 1 having support housing 2, a fluidic housing 3 supported by the support housing, an inlet source 4 in fluid communication with the fluidic housing to deliver viscous material to the fluidic housing, a nozzle assembly 5 provided at the end of the fluid housing, and a vertically disposed, reciprocating piston 6 positioned within the fluidic housing and configured to dispense material through the nozzle assembly. Certain dispense materials may contain suspended particles of conductive materials (silver) or insulating materials (silica). These particles can be drawn into the sliding interface between the reciprocating piston 6 and a typical U-cup seal 7. Over time, the U-cup seal 7 can wear and/or particles can build up between the piston 6 and seal and create a leak path.

### SUMMARY OF THE DISCLOSURE

One aspect of the present disclosure is directed to a dispensing system to dispense viscous material on an electronic substrate. In one embodiment, the dispensing system comprises a frame and a support coupled to the frame. The support is configured to receive and support an electronic substrate during a dispense operation. The dispensing system further comprises a dispensing unit assembly configured to dispense viscous material and a gantry coupled to the frame. The gantry is configured to support the dispensing unit assembly and to move the dispensing unit assembly in x-axis and y-axis directions. The dispensing unit assembly includes a dispensing unit configured to dispense viscous material. The dispensing unit includes a support housing and a fluidic housing supported by the support housing. The fluidic housing includes a chamber and an inlet configured to deliver viscous material to the chamber from a material feed tube. The dispensing unit further includes a nozzle assembly releasably secured to the housing and configured to close an end of the fluidic housing. The dispensing unit further includes a reciprocating piston disposed partially within the chamber of the fluidic housing. The piston is configured to dispense viscous material from the nozzle assembly. The dispensing unit further includes a fixed flexible diaphragm seal configured to be secured to the fluidic housing and to the piston.

Embodiments of the dispensing assembly further may include configuring the diaphragm seal to include an inner hub that is sized to fit within a reduced-diameter notch formed in the piston, an outer hub that is sized to be compression fit within the fluidic housing, and a flexible diaphragm portion that connects the inner hub and the outer hub. The flexible diaphragm portion may be configured to flex as the piston reciprocates up and down within the fluidic housing. The nozzle assembly further may include a nozzle nut, a nozzle, and a nozzle adapter. The nozzle nut may be threadably secured to a lower portion of the support housing and configured to secure the nozzle, the nozzle adapter, and a valve seat between the nozzle nut and the lower end of the fluidic housing. The dispensing unit further may include an O-ring to seal the valve seat with a bottom of the fluidic housing. The valve seat may include a generally cylindrical member having a conical surface and a small-diameter bore formed therein.

Another aspect of the present disclosure is directed to a dispensing unit of a dispensing system configured to dispense viscous material on an electronic substrate. In one embodiment, the dispensing unit comprising a support housing and a fluidic housing supported by the support housing. The fluidic housing includes a chamber and an inlet configured to deliver viscous material to the chamber from a material feed tube. The dispensing unit further comprises a nozzle assembly releasably secured to the housing and configured to close an end of the fluidic housing. The dispensing unit further comprises a reciprocating piston disposed partially within the chamber of the fluidic housing. The piston is configured to dispense viscous material from the nozzle assembly. The dispensing unit further comprises a fixed flexible diaphragm seal configured to be secured to the fluidic housing and to the piston.

Embodiments of the dispensing unit further may include configuring the diaphragm seal to include an inner hub that is sized to fit within a reduced-diameter notch formed in the piston, an outer hub that is sized to be compression fit within the fluidic housing, and a flexible diaphragm portion that connects the inner hub and the outer hub. The flexible diaphragm portion may be configured to flex as the piston reciprocates up and down within the fluidic housing. The nozzle assembly further may include a nozzle nut, a nozzle, and a nozzle adapter. The nozzle nut may be threadably secured to a lower portion of the support housing and configured to secure the nozzle, the nozzle adapter, and a valve seat between the nozzle nut and the lower end of the fluidic housing. The dispensing unit further may include an O-ring to seal the valve seat with a bottom of the fluidic housing. The valve seat may include a generally cylindrical member having a conical surface and a small-diameter bore formed therein.

Yet another aspect of the present disclosure is directed to a method of dispensing viscous material on an electronic substrate. In one embodiment, the method comprises: delivering an electronic substrate to a dispense position; capturing at least one image of the electronic substrate; analyzing the at least one image of the electronic substrate to determine a position of the electronic substrate; and performing a dispense operation with a dispensing unit including a support housing, a fluidic housing supported by the support housing, the fluidic housing includes a chamber and an inlet configured to deliver viscous material to the chamber from a material feed tube, a nozzle assembly releasably secured to the housing and configured to close an end of the fluidic housing, a reciprocating piston disposed partially within the chamber of the fluidic housing, the piston being configured to dispense viscous material from the nozzle assembly, and a fixed flexible diaphragm seal configured to be secured to the fluidic housing and to the piston.

Embodiments of the method further may include configuring the diaphragm seal to include an inner hub that is sized to fit within a reduced-diameter notch formed in the piston, an outer hub that is sized to be compression fit within the fluidic housing, and a flexible diaphragm portion that connects the inner hub and the outer hub. The flexible diaphragm portion may be configured to flex as the piston reciprocates up and down within the fluidic housing.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a cross-sectional view of a portion of a dispensing unit showing a traditional piston and seal design;

FIG. 2 is a schematic view of a dispensing system;

FIG. 3 is a cross-sectional view of a portion of a dispensing unit showing a piston having a fixed flexible diaphragm seal of an embodiment of the present disclosure;

FIG. 4 is an enlarged cross-sectional view of the portion of the dispensing unit showing the diaphragm seal;

FIG. 5 is an exploded perspective view of the portion of the dispensing unit;

FIG. 6A is a perspective view of a portion of the piston without the diaphragm seal; and

FIG. 6B is a perspective view of the portion of the piston shown in FIG. 6A with the diaphragm seal.

### DETAILED DESCRIPTION OF THE DISCLOSURE

Various embodiments of the present disclosure are directed to viscous material dispensing systems, devices including dispensing systems. Embodiments disclosed herein are directed to techniques for dispensing material on an electronic substrate by a dispensing system having a dispensing unit having a fixed flexible diaphragm seal that is configured to seal a reciprocating piston of a dispensing unit between the pressurized fluid inside a fluidic chamber and atmosphere. Typical sliding-type seals used in prior dispensing units can wear and develop leaks over time. This results in undesirably frequent maintenance intervals and/or seal replacement. In one embodiment of the present disclosure, an elastomer diaphragm, fixed at either end, creates a seal with the piston. The elastomer flexes as the piston oscillates instead of sliding against the piston as in a U cup-type seal. Because the seal has no sliding interfaces, there is nothing to wear out and create a leak path.

In one embodiment, the diaphragm seal is configured to include an outer flange, a flexible web, and an inner flange, all molded together out of an elastomer material. The outer flange is compressed between two housings at assembly to form a static seal. The inner flange fits into a notch provided on the piston shaft to prevent sliding on the shaft after assembly. Fluid pressure acts on the inner flange compressing it against the shaft and effectively sealing the interface between the seal and shaft. The flexible web between the two flanges flexes as the piston moves axially, allowing the piston to move freely but still provide a seal between the inner fluid pressure and atmosphere.

For the purposes of illustration only, and not to limit the generality, the present disclosure will now be described in detail with reference to the accompanying figures. This disclosure is not limited in its application to the details of construction and the arrangement of components set forth in the following description or illustrated in the drawings. The principles set forth in this disclosure are capable of other embodiments and of being practiced or carried out in various ways. Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated reference is supplementary to that of this document; for irreconcilable inconsistencies, the term usage in this document controls.

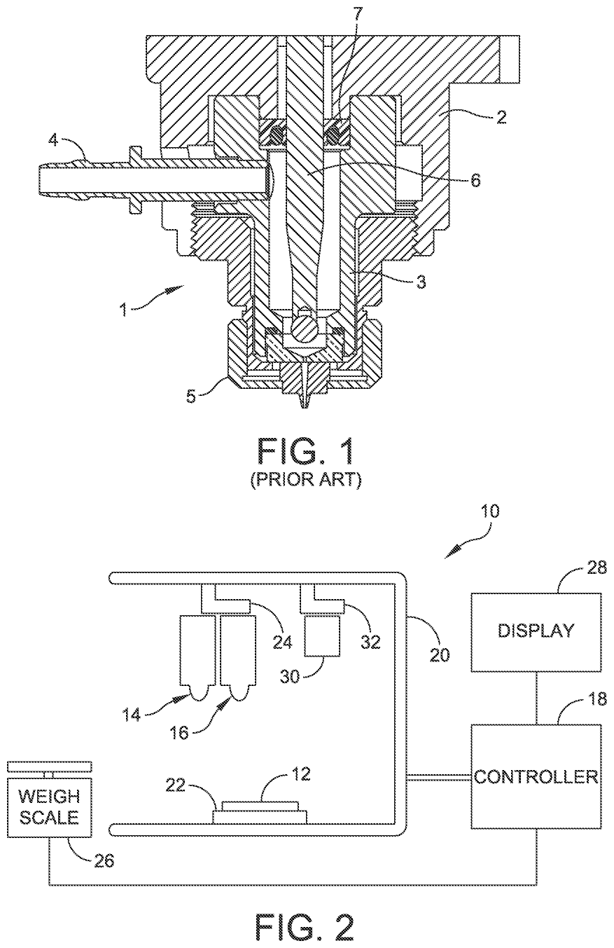

FIG. 2 schematically illustrates a dispensing system, generally indicated at 10, according to one embodiment of the present disclosure. The dispensing system 10 is used to dispense a viscous material (e.g., an adhesive, encapsulent, epoxy, solder paste, underfill material, etc.) or a semi-viscous material (e.g., soldering flux, etc.) onto an electronic substrate 12, such as a printed circuit board or semiconductor wafer. The dispensing system 10 may alternatively be used in other applications, such as for applying automotive gasketing material or in certain medical applications or for applying conductive inks. It should be understood that references to viscous or semi-viscous materials, as used herein, are exemplary and intended to be non-limiting. In one embodiment, the dispensing system 10 includes first and second dispensing units, generally indicated at 14 and 16, respectively, and a controller 18 to control the operation of the dispensing system. It should be understood that dispensing units also may be referred to herein as dispensing pumps and/or dispensing heads. Although two dispensing units are shown, it should be understood that a single dispensing unit or multiple dispensing units can be employed.

The dispensing system 10 may also include a frame 20 having a base or support 22 for supporting the electronic substrate 12, a dispensing unit gantry 24 movably coupled to the frame 20 for supporting and moving the dispensing units 14, 16, and a weight measurement device or weigh scale 26 for weighing dispensed quantities of the viscous material, for example, as part of a calibration procedure, and providing weight data to the controller 18. A conveyor system (not shown) or other transfer mechanism, such as a walking beam, may be used in the dispensing system 10 to control loading and unloading of electronic substrates to and from the dispensing system. The gantry 24 can be moved using motors under the control of the controller 18 to position the dispensing units 14, 16 at predetermined locations over the electronic substrate. The dispensing system 10 may include a display unit 28 connected to the controller 18 for displaying various information to an operator. There may be an optional second controller for controlling the dispensing units. Also, each dispensing unit 14, 16 can be configured with a z-axis sensor to detect a height at which the dispensing unit is disposed above the electronic substrate 12 or above a feature mounted on the electronic substrate. The z-axis sensor is coupled to the controller 18 to relay information obtained by the sensor to the controller.

Prior to performing a dispensing operation, as described above, the electronic substrate, e.g., the printed circuit board, must be aligned or otherwise in registration with a dispensing unit of the dispensing system. The dispensing system further includes a vision system 30, which, in one embodiment, is coupled to a vision system gantry 32 movably coupled to the frame 20 for supporting and moving the vision system. In another embodiment, the vision system 30 may be provided on the dispensing unit gantry 24. As described, the vision system 30 is employed to verify the location of landmarks, known as fiducials, or components on the electronic substrate. Once located, the controller can be programmed to manipulate the movement of one or more of the dispensing units 14, 16 to dispense material on the electronic substrate.

Systems and methods of the present disclosure are directed to dispensing material onto an electronic substrate, e.g., a printed circuit board. The description of the systems and methods provided herein reference exemplary electronic substrates 12 (e.g., printed circuit boards), which are supported on the support 22 of the dispensing system 10. In one embodiment, the dispense operation is controlled by the controller 18, which may include a computer system configured to control material dispensing units. In another embodiment, the controller 18 may be manipulated by an operator. The controller 18 is configured to manipulate the movement of the vision system gantry 32 to move the vision system so as to obtain one or more images of the electronic substrate 12. The controller 18 further is configured to manipulate the movement of the dispensing unit gantry 24 to move the dispensing units 14, 16 to perform dispensing operations.

The methods disclosed herein further support the use of various types of dispensing units, including, but not limited to, auger, piston and jetting pumps.

In one embodiment, an exemplary dispensing system described herein may embody Camalot® dispensing systems sold by ITWEAE of Hopkinton, Mass..

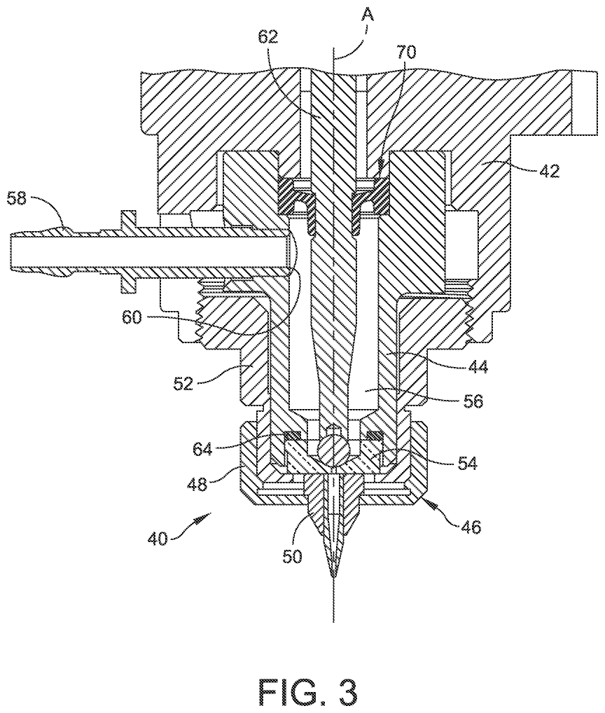

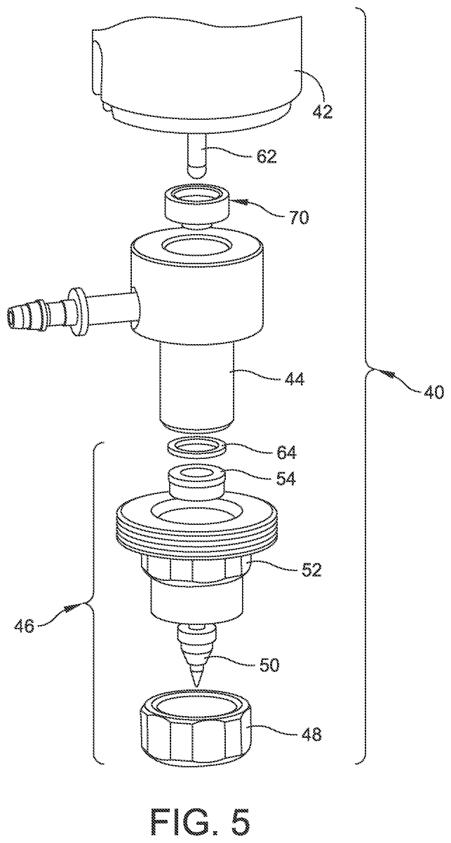

Referring to FIGS. 3 and 5, a portion of a dispensing unit of an embodiment of the present disclosure is generally indicated at 40. As shown, the dispensing unit 40 includes a support housing 42, a fluidic housing 44 supported by the support housing, and a nozzle assembly, generally indicated at 46, which is releasably secured to the support housing and closes an end of the fluidic housing. Specifically, the support housing 42, which is coupled to an actuator along axis A, is configured to support the fluidic housing 44, which receives viscous material for dispensing. The fluidic housing 44 is secured in place by the nozzle assembly 46, which, in one embodiment, includes a nozzle nut 48, a nozzle 50, a nozzle adapter 52, and a valve seat 54 upon which the lower portion of the fluidic housing rests. The fluidic housing 44 defines a cylindrical chamber 56 that is in fluid communication with a material feed tube 58, which is adapted to receive material from a material supply assembly. As shown, the material feed tube 58 introduces viscous material, e.g., solder paste or epoxy, within the chamber 56 of the fluidic housing 44 through an inlet 60 formed in the fluidic housing.

In some embodiments, the nozzle assembly 46 can be configured without the valve seat, including only nozzle nut 48, the nozzle 50 and the nozzle adapter 52.

The dispensing unit 40 further includes a reciprocating piston 62 that is partially disposed within the chamber 56 of the fluidic housing 44. The piston 62 has an upper end that is biased by a yoke in a downward manner by a spring and a plunger, or directly to a pneumatic cylinder, which is actuated by the actuator, and a lower end configured to engage the valve seat 54. The piston 62 is configured to be received and slidably moved within the chamber 56 of the fluidic housing 44 along axis A.

In one embodiment, the nozzle adapter 52 is threadably secured to the lower portion of the support housing 42 and configured to secure the valve seat 54 between the nozzle adapter 52 and the lower end of the fluidic housing 44. The nozzle nut 48 is threadably secured to a lower portion of the nozzle adapter 52 and configured to secure the nozzle 50, to the valve seat 54. As shown in FIG. 5, an O-ring 64 is provided to seal the valve seat 54 with the bottom of the fluidic housing 44. The valve seat 54 includes a generally cylindrical member having a conical surface and a small-diameter bore, e.g., 0.010 inches in diameter, through which the fluid is moved towards the nozzle. In one embodiment, the valve seat 54 may be fabricated from a hard material, such as tungsten carbide. The arrangement is such that viscous material is ejected from the small-diameter bore, e.g., 0.005 inches in diameter, formed in the nozzle, onto a substrate, e.g., circuit board 12, when the piston 62 is moved downwardly to engage the valve seat 54.

In a particular embodiment, the nozzle assembly 46 may be provided as a complete assembly (the nozzle nut 48, the nozzle 50) to the end user of the dispensing system 10 to aid in cleaning of the nozzle assembly. Specifically, a used nozzle assembly 46 may be completely removed from the support housing 42 of the dispensing unit 40 by unscrewing the nozzle nut 48 and replaced with a new (clean) nozzle assembly. Additionally, the nozzle adapter 52, the valve seat 54, the O-ring 64, and the fluidic housing 44 can be provided as an assembly to aid in the fluidic maintenance.

In some embodiments, with a nozzle assembly 46 that does not include the valve seat, the O-ring 64 provides a seal between the nozzle 50 and the bottom of the fluidic housing 44.

In operation, the reciprocating piston 62 is moveable between an upper position and a lower position within the chamber 56 of the fluidic housing 44. The dispensing medium, e.g., solder paste or epoxy, is introduced under pressure into the chamber 56 of the fluid housing 44 through the inlet 60 from the material feed tube 58 and the dispensing material flows through the fluidic housing 44 to an open space above the valve seat 54. In the lower position, the piston 62 is seated against the valve seat 54 and in the upper position, the piston is raised out of the valve seat of the nozzle assembly 46. In one embodiment, the actuator assembly includes one of a piezoelectric actuator, pneumatic actuator or a voice coil motor, which is coupled to the piston 62, and operation of the actuator assembly causes the movement of the piston between the upper and lower positions. When the piston 62 moves to its lowered position against the valve seat 54, a small drop of material is dispensed through the small diameter bore formed in the nozzle.

In some embodiments, the piston 62 is configured to cause material to be dispensed from the nozzle 50 of the nozzle assembly 46 by engaging the valve seat 54 thereby forcing material through the small diameter bore of the nozzle.

In other embodiments, the piston 62 is configured to cause material to be dispensed from the nozzle 50 of the nozzle assembly 46 without the valve seat 54 by forcing material within the chamber 56 through the small diameter bore of the nozzle.

In one embodiment, the dispensing unit 40 provides pressurized air to the source of dispensing material to introduce the material into the fluidic housing 44 of the dispensing unit through the material feed tube 58. The particular pressure provided may be selected based on the material being used, volume of material being dispensed, and mode of operation of the dispensing unit 40. During operation of the dispensing system 10, a user, through the user interface for the dispensing platform, i.e., display unit 28, defines dispensing areas on a circuit board. The dispensing unit 40 may be used to dispense dots and lines of material. When the dispensing unit 40 is used to dispense lines of material formed through multiple dispensing cycles of the dispensing system 10 and is used to dispense material at selected locations on a circuit board or other substrate using an individual dispensing cycle. For lines of material, a user defines the start and stop positions of a line, and the dispensing platform is able to move the dispensing unit 40 to place material along the line. Once all dispensing areas on a circuit board are defined and the dispensing parameters set using a dispensing unit control panel, the dispensing system is able to receive circuit boards for processing. After moving a circuit board to a dispensing location, the dispensing system 10 controls the gantry system 24 to position the dispensing unit 40 over a dispensing location. In another embodiment, the circuit board may be moved under a stationary dispensing unit. Dispensing for a particular board will continue until material has been dispensed at all locations on the board. The board is then unloaded from the system and a new board can be loaded into the system.

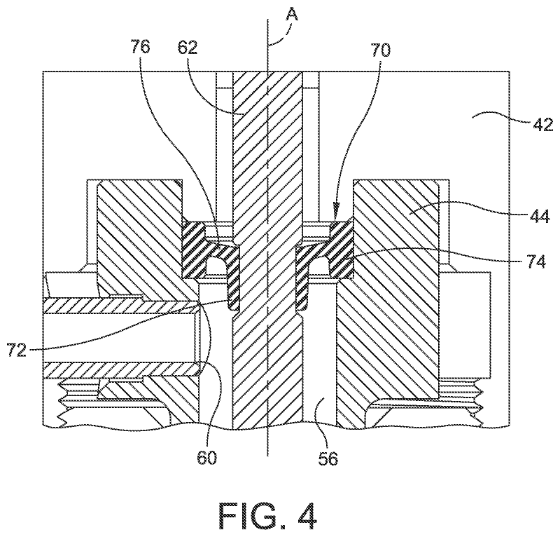

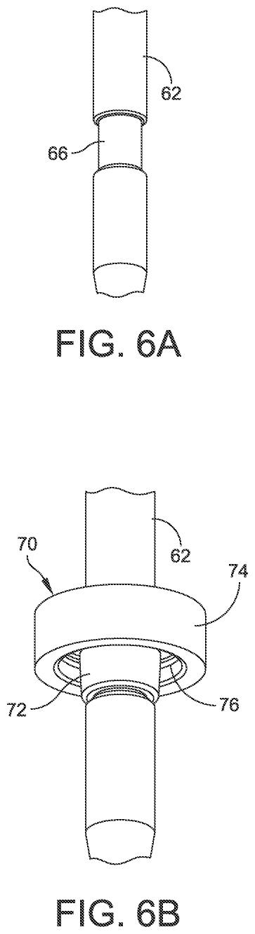

Referring additionally to FIGS. 4, 6A and 6B, the dispensing unit 40 further includes a fixed flexible diaphragm seal, generally indicated at 70, that is secured to the fluidic housing 44 and to the piston 62. Specifically, the diaphragm seal 70 includes an inner hub 72 that is sized to fit within a reduced-diameter notch 66 formed in the piston 62, an outer hub 74 that is sized to be compression fit within the fluidic housing 44, and a flexible diaphragm portion 76 that connects the inner hub and the outer hub. The flexible diaphragm portion 76 of the diaphragm seal 70 is configured to flex as the piston 62 reciprocates up and down within the fluidic housing 44. In one embodiment, the material used to create the diaphragm seal 70 is an elastomer material, e.g., ethylene propylene rubber (EPM), that is molded to create the diaphragm seal. Other suitable materials may also be used, e.g., ethylene propylene diene monomer rubber (EPDM), a fluoroelastomer material (FKM), or a thermoplastic polyurethane elastomer material (TPU).

In the shown embodiment, the inner hub 72 is concentrically positioned within the outer hub 74 of the diaphragm seal 70 about axis A. As best shown in FIG. 4, the inner hub 72 of the diaphragm seal 70 extends downwardly with respect to the outer hub 74, with the flexible diaphragm portion 76 connecting an upper portion of the inner hub and a central- or mid-portion of the outer hub. This construction enables the flexible relative movement of the piston 62 and the inner hub 72 of the diaphragm seal 70 with respect to the outer hub 74 and the fluidic housing 44. The result is that fluidic pressure within the fluidic housing 44 causes the inner hub 72 of the diaphragm seal 70 to seal against the piston 62 within the notch 66 of the piston. One advantage of this design is that there is little to no friction on the piston 62 during operation, i.e., the reciprocal movement of the piston within the fluidic housing 44. Another advantage is that the diaphragm seal 70 is low cost to produce. Yet another advantage is that the diaphragm seal 70 has no sliding interface with the piston 62 or the fluidic housing 44 to eliminate or severely reduce leaking between the interface.

Thus, it should be observed that the static angle of the flexible web, i.e., flexible diaphragm portion 76, between the inner hub 72 and the outer hub 74 is such that the flexible web is always in compression and never in tension to reduce stress on the elastomer, improving the life of the seal. The area of the flexible web is kept to a minimum for durability and to minimize distortion while exposed to traditional fluid pressures inside the fluidic (up to 60 psi).

Embodiments of the diaphragm seal 70 of the present disclosure may be used in a wide variety of dispensing units that employ a reciprocating piston to dispense the fluid. The diaphragm seal 70 enables extended maintenance periods for all applications or, in the case of some dispense materials, the ability to provide a hardware and process solution without leaking.

Thus, it should be observed that the fixed flexible diaphragm seal 70 of embodiments of the present disclosure is particularly suited to allow for acceptable maintenance frequency for a dispensing pump on a production assembly line. By eliminating the sliding interface of a traditional U-cup type seal, e.g., U-cup seal 7, maintenance frequency of the dispense tool can be scheduled around the life of the material being dispensed, and not the dispense tool hardware.

Having thus described several aspects of at least one embodiment of this disclosure, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A dispensing system to dispense viscous material on an electronic substrate, the dispensing system comprising:
a frame;
a support coupled to the frame, the support being configured to receive and support an electronic substrate during a dispense operation;
a dispensing unit assembly configured to dispense viscous material; and
a gantry coupled to the frame, the gantry being configured to support the dispensing unit assembly and to move the dispensing unit assembly in x-axis and y-axis directions,
wherein the dispensing unit assembly includes a dispensing unit configured to dispense viscous material, the dispensing unit including
a support housing,
a fluidic housing supported by the support housing, the fluidic housing including a chamber and an inlet configured to deliver viscous material to the chamber from a material feed tube,
a nozzle assembly releasably secured to the housing and configured to close an end of the fluidic housing,
a reciprocating piston disposed partially within the chamber of the fluidic housing, the piston being configured with the nozzle assembly to dispense viscous material from the nozzle assembly, and
a fixed flexible diaphragm seal configured to be secured to the fluidic housing and to the piston.

2. The dispensing system of claim 1, wherein the diaphragm seal includes an inner hub, an outer hub, and a flexible diaphragm portion that connects the inner hub and the outer hub.

3. The dispensing system of claim 1, wherein the inner hub of the diaphragm seal is sized to fit within a reduced diameter notch formed in the piston and the outer hub of the diaphragm seal is sized to be compression fit within the fluidic housing.

4. The dispensing system of claim 1, wherein the flexible diaphragm portion is configured to flex as the piston reciprocates up and down within the fluidic housing.

5. The dispensing system of claim 1, wherein the nozzle assembly further includes a nozzle nut, a nozzle, and a nozzle adapter.

6. The dispensing system of claim 5, wherein the nozzle nut is threadably secured to a lower portion of the support housing and configured to secure the nozzle and the nozzle adapter between the nozzle nut and the lower end of the fluidic housing.

7. The dispensing system of claim 6, wherein the valve assembly further includes a valve seat, and wherein the dispensing unit further includes an O-ring to seal the valve seat with a bottom of the fluidic housing.

8. The dispensing system of claim 5, wherein the valve seat includes a generally cylindrical member having a conical surface and a small-diameter bore formed therein.

9. A dispensing unit of a dispensing system configured to dispense viscous material on an electronic substrate, the dispensing unit comprising:
a support housing;
a fluidic housing supported by the support housing, the fluidic housing including a chamber and an inlet configured to deliver viscous material to the chamber from a material feed tube;
a nozzle assembly releasably secured to the housing and configured to close an end of the fluidic housing;
a reciprocating piston disposed partially within the chamber of the fluidic housing, the piston being configured with the nozzle assembly to dispense viscous material from the nozzle assembly; and
a fixed flexible diaphragm seal configured to be secured to the fluidic housing and to the piston.

10. The dispensing unit of claim 9, wherein the diaphragm seal includes an inner hub, an outer hub, and a flexible diaphragm portion that connects the inner hub and the outer hub.

11. The dispensing unit of claim 10, wherein the inner hub of the diaphragm seal is sized to fit within a reduced diameter notch formed in the piston and the outer hub is sized to be compression fit within the fluidic housing.

12. The dispensing unit of claim 9, wherein the flexible diaphragm portion is configured to flex as the piston reciprocates up and down within the fluidic housing.

13. The dispensing unit of claim 9, wherein the nozzle assembly further includes a nozzle nut, a nozzle, and a nozzle adapter.

14. The dispensing unit of claim 13, wherein the nozzle nut is threadably secured to a lower portion of the support housing and configured to secure the nozzle and the nozzle adapter between the nozzle nut and the lower end of the fluidic housing.

15. The dispensing unit of claim 14, wherein the valve assembly further includes a valve seat, and wherein the dispensing unit further includes an O-ring to seal the valve seat with a bottom of the fluidic housing.

16. The dispensing unit of claim 15, wherein the valve seat includes a generally cylindrical member having a conical surface and a small-diameter bore formed therein.

17. A method of dispensing viscous material on an electronic substrate, the method comprising:
delivering an electronic substrate to a dispense position;
capturing at least one image of the electronic substrate;
analyzing the at least one image of the electronic substrate to determine a position of the electronic substrate; and
performing a dispense operation with a dispensing unit including
a support housing,
a fluidic housing supported by the support housing, the fluidic housing includes a chamber and an inlet configured to deliver viscous material to the chamber from a material feed tube,
a nozzle assembly releasably secured to the housing and configured to close an end of the fluidic housing,
a reciprocating piston disposed partially within the chamber of the fluidic housing, the piston being configured to dispense viscous material from the nozzle assembly, and
a fixed flexible diaphragm seal configured to be secured to the fluidic housing and to the piston.

18. The method of claim 17, wherein the diaphragm seal includes an inner hub, an outer hub, and a flexible diaphragm portion that connects the inner hub and the outer hub.

19. The method of claim 18, wherein the inner hub of the diaphragm seal is sized to fit within a reduced diameter notch formed in the piston and the outer hub is sized to be compression fit within the fluidic housing.

20. The method of claim 17, wherein the flexible diaphragm portion is configured to flex as the piston reciprocates up and down within the fluidic housing.

21. The method of claim 17, wherein the nozzle assembly further includes a nozzle nut, a nozzle, and a nozzle adapter.

22. The method of claim 21, wherein the nozzle nut is threadably secured to a lower portion of the support housing and configured to secure the nozzle and the nozzle adapter between the nozzle nut and the lower end of the fluidic housing.

23. The method of claim 21, wherein the valve assembly further includes a valve seat, and wherein the dispensing unit further includes an O-ring to seal the valve seat with a bottom of the fluidic housing.
